(19) United States
(12) Patent Application Publication
(10) Pub. No.: US 2012/0066726 A1
(43) Pub. Date: Mar. 15, 2012

(54) Video Display Units for Aircraft In-Flight Entertainment Systems and Methods of Adapting the Same

(76) Inventors: Christopher K. Mondragon, Laguna Niguel, CA (US); Stuart Dunleavy, Rancho Santa Margarita, CA (US); Brett Bleacher, Rancho Santa Margarita, CA (US)

(21) Appl. No.: 13/229,058

(22) Filed: Sep. 9, 2011

Related U.S. Application Data
(60) Provisional application No. 61/381,694, filed on Sep. 10, 2010.

(51) Int. Cl. H04N 7/18; H04N 5/64

(52) U.S. Cl. 725/76; 348/837; 348/E05.129

(57) ABSTRACT

Some embodiments of the present invention provide video display units including at least one video display monitor at least one sheet of polarized material configured to extend on a viewing surface of the at least one video display monitor. The video display unit is adapted for use in an aircraft in-flight entertainment system. Some video display units include a plurality of video display monitors. Related methods are also provided.

### CLAIM OF PRIORITY

This application claims priority from U.S. Provisional Application No. 61/381,694, filed Sep. 10, 2010, the disclosure of which is hereby incorporated herein as if set forth in its entirety.

### FIELD

Various embodiments described herein relate to video displays and, more particularly, to video display units adapted for use in aircrafts.

### BACKGROUND

In-flight entertainment systems have been deployed onboard aircraft to provide entertainment for passengers in a passenger cabin. The in-flight entertainment systems typically provide passengers with video and audio programming. Some in-flight entertainment systems include an electronic communications network having a head-end server and seat-end electronics boxes coupled with video display units that display content distributed to the seat-end electronics boxes from the head-end server over the communications network.

Typically, only a single video display unit is disposed at a single passenger seat in the seatback, and the video display unit includes a single monitor. Thus, passengers are typically only able to view one programming channel, for example, a movie, TV show and the like or play one video game at a time.

### SUMMARY

Some embodiments of the present invention provide video display units including at least one video display monitor having at least one sheet of polarized material configured to extend in a viewing surface of the at least one video display monitor. The video display unit is adapted for use in an aircraft in-flight entertainment system.

In further embodiments, the at least one video display monitor may be a plurality of video display monitors, each of the plurality of video display monitors having an associated viewing surface. In these embodiments, the at least one sheet of polarized material may be configured to extend over substantially all the viewing surfaces of the plurality of video display monitors.

In still further embodiments, each of the plurality of video display monitors may be configured to display video content distinct from remaining ones of the plurality of video display monitors.

In some embodiments, each of the plurality of video display monitors may be configured to be powered on and/or off independently of remaining ones of the plurality of video display monitors.

In further embodiments, the at least one sheet of polarized material may be a plurality of sheets of polarized material corresponding to each of the plurality of video display monitors. Each of the plurality of sheets of polarized material may be configured to extend over substantially all the viewing surface of the corresponding video display monitor.

In still further embodiments, the at least one sheet of polarized material may be active polarized glass, passive polarized glass, active polarized plastic and/or passive polarized plastic.

In some embodiments, the video display unit may be adapted for use in an aircraft in-flight entertainment system by being adapted to comply with at least one of electro-magnetic interface standards, flammability standards, head-impact compatibility standards and environmental standards including shock and vibration.

In further embodiments, the at least one sheet of polarized material may be a mirrored surface and wherein the video display monitor is disposed behind the mirrored surface. In certain embodiments, the video display monitor is configured to be unnoticed behind the mirrored surface when the video display monitor is powered off and to be viewed through the mirrored surface when the video display monitor is powered on.

In still further embodiments, the video display monitor is disposed in a seatback of the aircraft and/or a tabletop in the aircraft.

In some embodiments, the video display monitor may include an interactive screen configured to generate a signal in response to contact by a user.

In further embodiments, the video display unit may further include a camera configured to provide camera gesture recognition control such that the video display unit can be controlled responsive to gestures of a user.

In still further embodiments, the at least one polarized surface includes at least one of a lighting effect and a logo effect.

In some embodiments, the video display unit further includes a processor coupled to the at least one video display monitor. The processor is configured to receive input from a user through a user interface associated with the at least one video display monitor and alter content of the at least one video display monitor based on the received input from the user.

In further embodiments, the video display unit further includes an in-flight entertainment system coupled to the processor.

Still further embodiments provide video display units including a plurality of video display monitors and a sheet of polarized material configured to extend on substantially all viewing surfaces of the plurality of video display monitors. The video display unit is adapted for use in an aircraft in-flight entertainment system such that the video display unit complies with standards of the federal aviation administration and/or aircraft manufacturers.

Some embodiments provide methods of providing a video display unit for an aircraft, the method including providing at least one video display monitor having a sheet of polarized material over substantially all of a viewing surface of the at least one video display monitor; and adapting the video display unit for use in an aircraft in-flight entertainment system by modifying the video display unit to comply with standards associated with the federal aviation administration.

In further embodiments, adapting the video display unit for use in an aircraft in-flight entertainment system may include modifying the video display unit to comply with standards associated with an aircraft manufacturer.

In still further embodiments, adapting the video display unit for use in an aircraft in-flight entertainment system by modifying the video display unit to comply with standards associated with the federal aviation administration may include modifying the video display unit to comply with at least one of electro-magnetic interface standards, flammability standards, head-impact compatibility standards and environmental standards including shock and vibration.

In some embodiments, providing the at least one video display monitor may include providing a plurality of video display monitors, each of the plurality of video display monitors having an associated viewing surface. The sheet of polarized material may be configured to extend over substantially all the viewing surfaces of the plurality of video display monitors.

In further embodiments, the method may further include positioning the at least one video display unit in a seatback of the aircraft, behind a mirrored surface in the aircraft and/or in a tabletop of the aircraft.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a diagram illustrating video display units in accordance with some embodiments discussed herein.

FIG. 2 is a diagram illustrating multi-monitor video display units in accordance with some embodiments discussed herein.

FIGS. 3A and 3B are diagrams illustrating embodiments including video display monitors in tabletops according to some embodiments discussed herein.

FIG. 4 is a diagram illustrating a multi-monitor video display unit positioned in a tabletop in accordance with some embodiments discussed herein.

FIG. 5 is a diagram illustrating video display monitors disposed in seatbacks in accordance with some embodiments discussed herein.

FIG. 6 is a block diagram of a system including video display monitors in an aircraft in-flight entertainment system in accordance with some embodiments discussed herein.

FIGS. 7 and 8 are flowcharts illustrating methods of providing video display units in an aircraft in accordance with various embodiments discussed herein.

### DETAILED DESCRIPTION OF EMBODIMENTS

As discussed above, it is becoming more common to have in-flight entertainment systems onboard aircraft to provide entertainment for passengers in a passenger cabin. However, conventional in-flight entertainment systems are typically disposed at a single passenger seat in the seatback and only include a single video display monitor. Thus, passengers are typically only able to view one programming channel, for example, a movie, TV show and the like or play one video game at a time.

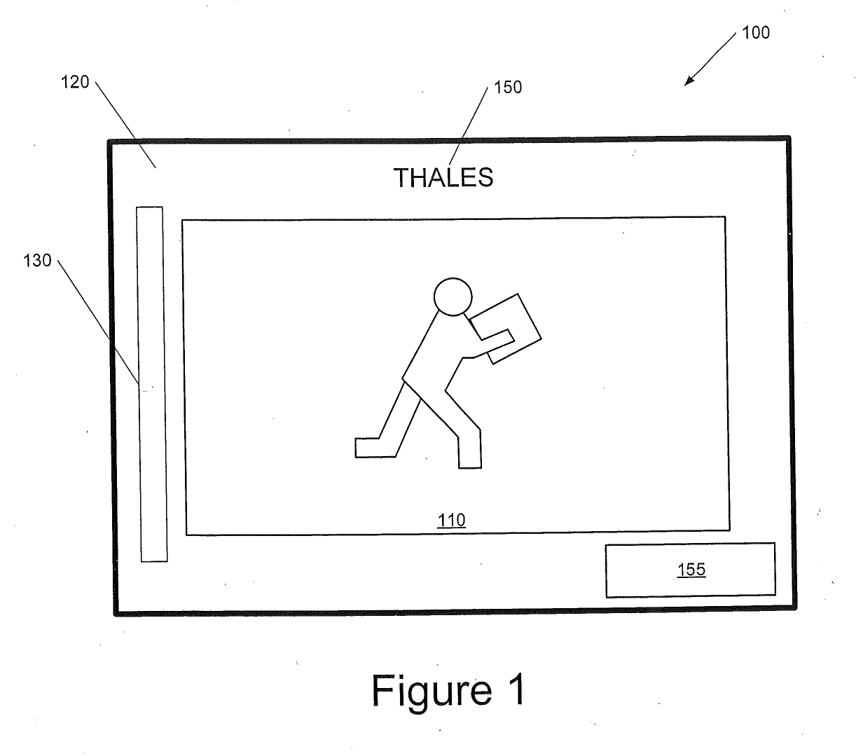

Thus, some embodiments of the present invention provide multiple monitor video display units, which may provide benefits over the conventional in-flight entertainment systems. For example, according to some embodiments, video display units may include multiple video display monitors as will be discussed further herein with respect to FIGS. 1 through 8. Integrating multiple video display monitors in a single video display unit of an in-flight entertainment system may provide a multi-viewing experience at a single location.

It will be understood that while embodiments discussed herein are directed to in-flight entertainment systems, embodiments of the present invention are not limited to this configuration. For example, some embodiments of the multiple video display monitor video display unit described herein may be used in many other applications where a single display unit capable of displaying a plurality of distinct video images is desired. For example, embodiments of the present invention may be included in other vehicles, such as ships, buses, trains, and automobiles, as well as buildings, such as conference centers, restaurants, businesses, hotels, homes, and the like

Referring first to FIG. 1, a block diagram of a video display unit in accordance with some embodiments will be discussed. As illustrated in FIG. 1, a video display unit 100 may include a single video display monitor 110 having a sheet of polarized material 120 on a viewing surface thereof. As used herein, “polarized material” refers to both active and passive polarized glass as well as active and passive polarized plastic. As further illustrated in FIG. 1, the video display unit may optionally include lighting effects 130 and/or logo effects 150. These effects may be customized by the user. For example, Thales and/or a customer may choose to have a “THALES” or customer logo effect 150 prominently displayed on their products as illustrated in FIG. 1. Furthermore, the lighting effect 130 may be provided, in some embodiment, by light emitting diodes (LEDs) or may be a backlight having a color different from the overhead lights in the cabin.

Some embodiments of the video display unit 100 may include external ports 155 to allow a user to plug in external portable electronic devices (PEDs), such as video game consoles, cameras, tablets, laptops, an IPod or headphones. For example, the external ports 155 may be a universal serial bus (USB) port or a jack configured to receive headphones or the like. It will be understood that some embodiments of the present invention may be equipped with short range wireless capabilities, such as Bluetooth, and therefore may also connect to consoles, headphones and the like wirelessly without the use of a port or jack.

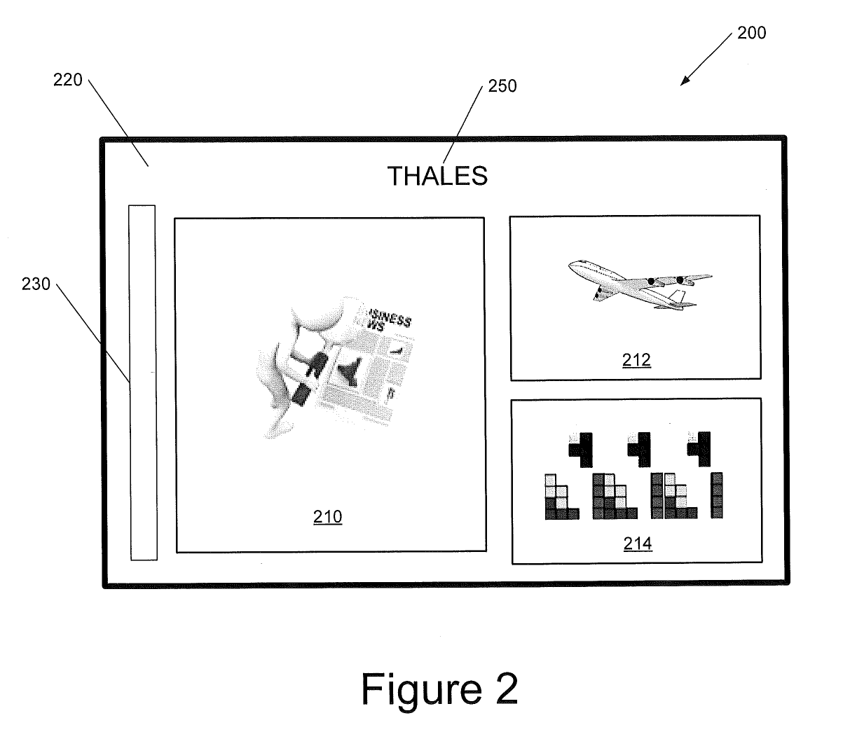

Referring now to FIG. 2, a diagram illustrating multi-monitor video display units in accordance with some embodiments discussed herein will be discussed. As illustrated in FIG. 2, the video display unit 200 may include multiple video display monitors 210, 212 and 214. It will be understood that although the video display unit 200 of FIG. 2 includes three video display monitors 210, 212 and 214, embodiments of the present inventive concept are not limited to this configuration. For example, two video display monitors or more than three video display monitors may be provided without departing from the scope of the present invention.

Referring again to FIG. 2, the sheet of polarized material 220 may extend over the viewing surfaces of all of the video display monitors 210, 212 and 214. In further embodiments, each of the video display monitors 210, 212 and 214 may have corresponding sheets of polarized material that extend only on the viewing surface associated with that video display monitor.

In some embodiments, each of the video display monitors 210, 212 and 214 is configured to display video content distinct from the other video display monitors 210, 212 and 214. As illustrated in FIG. 2, the user may watch news on a first video display monitor 210, view a map indicating a location of the aircraft in a second video display monitor 212 and play a video game on a third video display monitor 214. Similarly, in some embodiments, each of video display monitors 210, 212 and 214 may be powered on and/or off independently of remaining ones of the plurality of video display monitors.

The exemplary video display unit 200 illustrated in FIG. 2 includes a larger video display monitor 210 disposed on a left side of the video display unit 200, and two smaller video display monitors 212 and 214 disposed on a right side of the video display unit 200 in a vertical arrangement with respect to one another. The larger video display monitor 210 may have, for example, a 19 inch diagonal measurement, while the smaller video display monitors may have, for example, a 10 inch diagonal measurement. As discussed above, there may be fewer or more video display monitors included in the video display unit 200, and the video display monitors may be provided in a variety of different sizes, arrangements, and orientations without departing from the scope of the present invention. For example, there may be as few as one or two video display monitors, or as many as four, five, six, seven, eight, nine, ten, or more video display monitors included in the video display unit 200. In some embodiments, each of the video display monitors may range in size from a small size, such as 3.0 inches, to 8.9 inches, to 40 inches, or larger diagonal measurements. Larger size video display monitors and/or a greater quantity of video display monitors may be used when the video display unit 200 is installed in social and lounge areas of an aircraft, while smaller size video display monitors and/or a smaller quantity of video display monitors may be used for personal viewing at a passenger seat. Each of the video display monitors 210, 212 and 214 within the video display unit 200 may be disposed in a vertical configuration or a horizontal configuration, depending upon a desired viewing aspect ratio or external dimensional footprint.

As discussed above, the video display monitors 210, 212 and 214 may be turned on and off individually, may simultaneously display different video images from different video channels or sources, and may be individually adjustable for video display characteristics such as brightness, contrast, color balance, and the like. The different video images simultaneously displayed by the video display monitors 210, 212 and 214 may include a map including the aircraft location and direction relative to landmarks such as airports, cities and rivers; a video image of the landscape below the aircraft taken by an externally mounted camera; a video entertainment program such as a movie or television show; a video game display; a control menu; and/or textual information such as originating airport, destination airport, current location, (e.g., state, closest city, longitude and latitude, and/or GPS coordinates), airspeed, elevation, elapsed duration of flight, estimated time of arrival at destination, current weather at destination, external temperature, cabin temperature, and video source information for each of the video display monitors 210, 212 and 214, etc. In some embodiments, textual information may be overplayed on top of other video source information.

The video display unit 200 may also include a sheet of polarized material 220 which covers the front or essentially the full viewing area of all the video display monitors 210, 212 and 214. The sheet of polarized material 220 may be sized as appropriate to cover all the video display monitors 210, 212 and 214 for wall-mounting or back-of-seat installation of the video display unit. The polarized material 220 may include materials, compositions, and construction characteristics to provide a bright and clear display of the video display monitors 210, 212 and 214 to a passenger. In some embodiments, the polarized material 220 may include a reflective mirror surface which passengers may use as a personal mirror for viewing themselves when the video display unit 200 or the individual video display monitors 210, 212 and 214 are turned off or dark. The reflective mirror surface may include materials, compositions, and construction characteristics to avoid excessive glare to a passenger.

As further illustrated in FIG. 2, the video display unit 200 may also include a logo 250 with lighting effects and other lighting effects 230. In some embodiments, the logo with lighting effects 250 and/or the other lighting effects 230 may be integrated with the sheet of polarized material 220. The logo with lighting effects 250 and/or the other lighting effects 230 may illuminate the sheet of polarized material 220 and/or the video display unit 200 using any one or more of a plurality of colors at a plurality of brightness levels. The logo with lighting effects 250 and/or the other lighting effects 230 combined with the polarized material 220 may provide a unique look and/or set an environmental mood in the vicinity of the installation location of the video display unit 200.

In a seatback configuration, the video display unit 200 may include as few as one video display monitor 210, 212, 214 arranged within or situated behind the polarized material 220. In a common area or bar configuration, multiple video display monitors may be arranged within or situated behind the single sheet of polarized material 220 whereby passengers in the common area can view multiple programming channels simultaneously from the video display unit 200.

In various embodiments, the video display unit 200 may be constructed of appropriate materials to meet applicable aircraft industry standards and requirements. For example, a head impact criteria (HIC) test may be satisfied by the video display unit 200. The video display unit 100 may be ideally suited for extreme environments, such as that of an aircraft. These extreme environments may include vibration, large temperature variations, and shock/vibration which may cause reliability problems with standard commercial grade video display units.

In some embodiments, video display monitors may be repackaged along with any auxiliary electronics and power supply and will be required to meet, for example, federal aviation administration (FAA)/Airbus/Boeing aircraft certification, such as Electro-Magnetic Interface (EMI), Flammability, HIC Testing and Environmental conditions of the aircraft including shock and vibration.

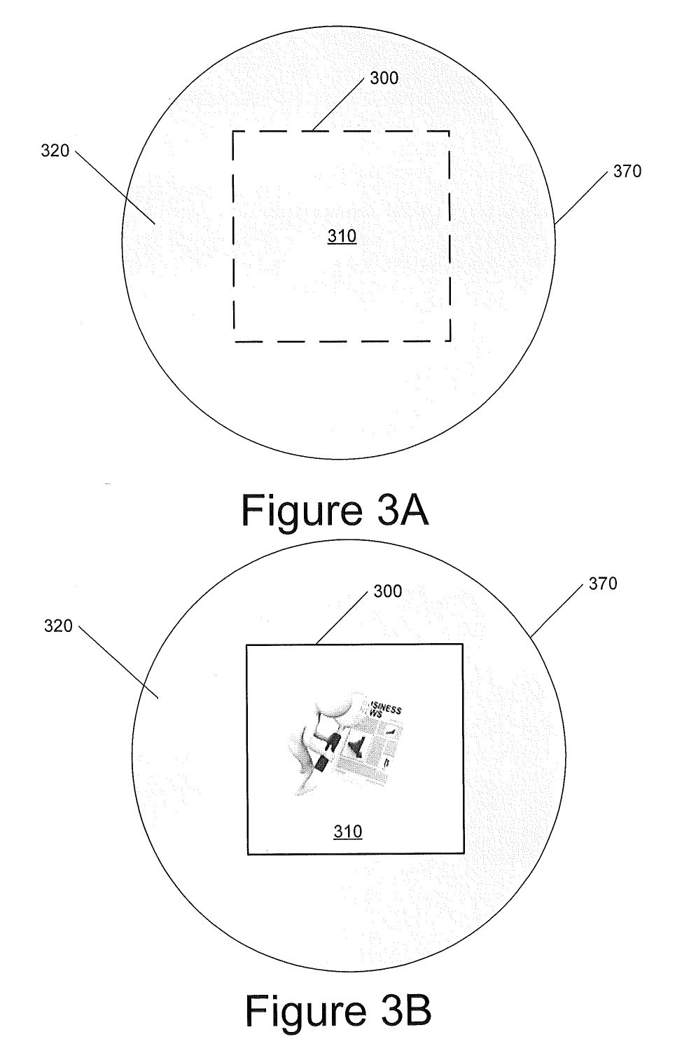

Video display units 100, 200 in accordance with embodiments of the present invention may be installed in various locations within an aircraft. For example, as illustrated in FIGS. 3A and 3B, a video display unit 300 may be disposed in a tabletop 370 in a bar/lounge area. In some of these embodiments, the sheet of polarized material 320 provided on the video display monitor may be a mirrored surface. Thus, in these embodiments, the video display unit 300 may be unnoticed behind the mirrored surface of the tabletop 370 when the video display unit 300 is powered off. This is illustrated in FIG. 3A, the dotted lines of the video display monitor 310 indicate that the display unit 300 is present in the tabletop 370, but is unnoticed by the user. However, as illustrated in FIG. 3B, when the video display unit 300 is powered on, the video display monitor 310 can be viewed through the mirrored surface 320 of the tabletop 370.

It will be understood that although embodiments are discussed herein having a mirrored surface on a tabletop, embodiments of the present invention are not limited to this configuration. For example, video display unit 300 may be provided behind mirrors on any surface in the aircraft, such as mirrors in the bathroom, behind a bar in a lounge and the like.

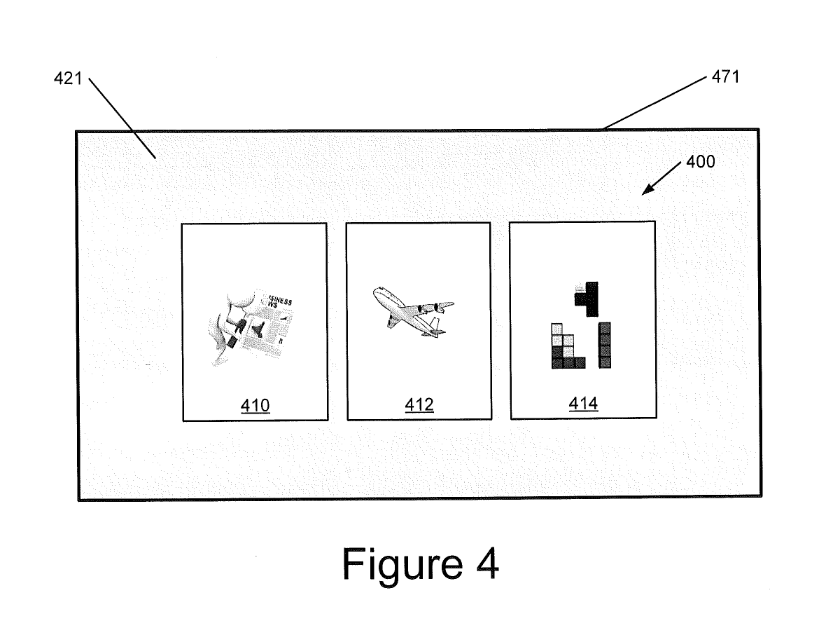

As further illustrated in FIG. 4, a multi-display video display unit similar to the display unit discussed above with respect to FIG. 2 may be positioned in a tabletop. As illustrated in FIG. 4, a multi-display video display unit 400 is positioned in a tabletop 471. As further illustrated, the display unit 400 includes three video display monitors 410, 412, 414 configured horizontally on the tabletop 471. In some embodiments, a sheet of polarized material 421 may be provided on the viewing surface of the video display monitors 410, 412 and 414, for example, a mirrored sheet of material as discussed above with respect to FIGS. 3A and 3B. Thus, the three monitors 410, 412 and 414 may be unnoticed in the tabletop 471 until one or more of them are powered on.

As discussed above with respect to FIG. 2, each of the video display monitors 410, 412 and 414 is configured to display video content distinct from the other video display monitors 410, 412 and 414. As illustrated in FIG. 4, the user may watch news on a first video display monitor 410, view a map indicating a location of the aircraft in a second video display monitor 412 and play a video game on a third video display monitor 414. Similarly, in some embodiments, each of video display monitors 410, 412 and 414 may be powered on and/or off independently of remaining ones of the plurality of video display monitors.

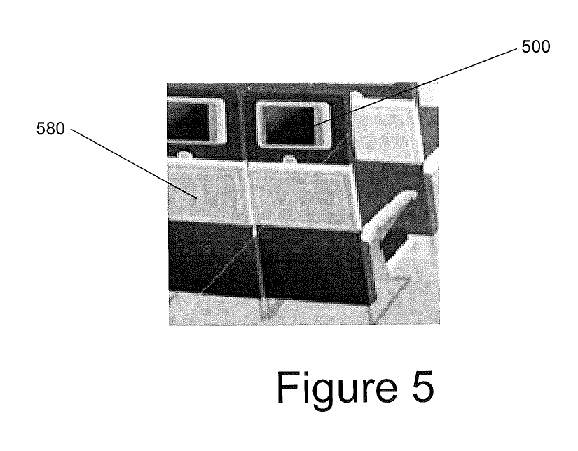

Furthermore, the video display unit 100, 200 may be installed in a common area, such as a galley or a lounge. As illustrated in FIG. 5, the video display unit 500 may be installed in a seatback 580 of a single passenger seat. In some embodiments, the video display units 500 may only be provided in business or premium class passenger seats.

As illustrated in FIGS. 1 through 5, video display units 100, 200, 300, 400, 500 in accordance with embodiments discussed herein may include a number of components. In various embodiments, some of the illustrated components may not be present and/or additional components as known in the art may be additionally included. For example, although FIG. 1 is illustrated as including external ports 155, external ports 155 may not necessarily be present in all video display units in accordance with embodiments of the present invention. The components of video display units and arrangement thereof portrayed in the Figures are not to be considered to limit the invention, but are to be considered exemplary to illustrate concepts of the invention.

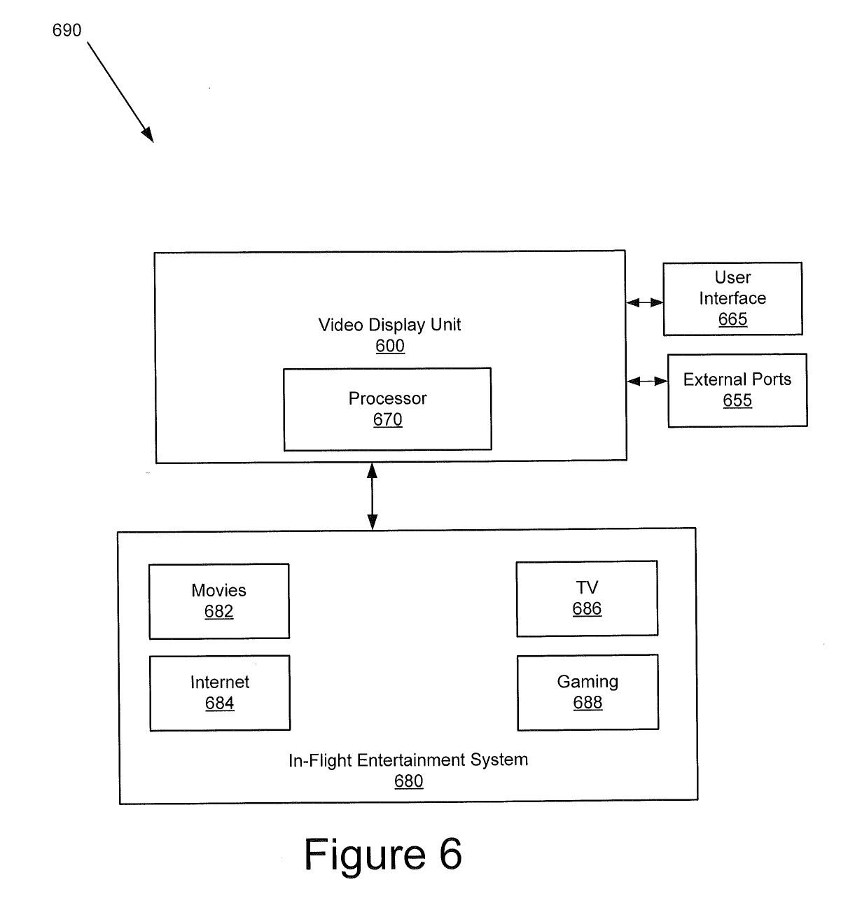

Referring now to FIG. 6, a block diagram of a system 690 including video display units 600 in accordance with some embodiments will be discussed. As illustrated in FIG. 6, the system includes a video display unit 600 coupled to an in-flight entertainment system 680 through a processor 670. As further illustrated in FIG. 6, a user interface 665 is coupled to the video display unit 600 and the in-flight entertainment system 680 through the processor 670. Although the processor is illustrated in FIG. 6 as being part of the video display unit 600 and separate from the in-flight entertainment system 680, it will be understood that these elements may be combined in some embodiments. For example, the processor 670 may be included in the in-flight entertainment system 680 or separate from both the video display unit 600 and the in-flight entertainment system 680 without departing from the scope of the present application.

The video display unit 600 may be any of the video display units 100, 200, 300, 400, 500 discussed above. As illustrated in FIG. 6, the user may interact with the video display unit 600 using a user interface 665. This user interface 665 may be any type of interface known to those having skill in the art. For example, some video display units 600 in accordance with embodiments discussed herein may include touchscreen monitors, which allow the user to select options by making contact with a screen of the video display unit. However, in some embodiments the monitors may not include touchscreens, and other technologies besides touchscreen technology may be used to provide input to the video display unit 600 without departing from the present inventive concept.

In some embodiments, video display unit 600 may include a smart video display unit, for example, for installation at a passenger seat as shown in FIG. 5 or a smart monitor, for example, for installation in common areas of an aircraft. The video display unit 600 may provide additional functionality beyond the display of video content, such as electronic communications, input functionality, and/or local computing functionality using a processor. The electronic communications may include Ethernet network communications, Universal Serial Bus (USB) communications, wireless communications, such as WiFi and Bluetooth, and optical communications, such as infrared communications. As discussed above, the video display unit 600 may also include electronic communications ports 655 that facilitate external input/output components, such as keyboards, mice, trackballs, light-pens, joysticks, gaming controls, CD-ROM drives, DVD drives, thumbdrives, personal audio and video players, and the like, to be electronically coupled with the video display unit 600 to be used in conjunction therewith.

The in-flight entertainment system 680 may provide all types of entertainment to a passenger of the aircraft. For example, the in-flight entertainment system may provide movies 682, Internet access 684, Television 686 (via cable or satellite), gaming 688 etc. The passenger may access these activities from the video display monitor 600 through the processor 670. Some embodiments of the present invention may be used in combination with wireless headsets, gesture technology, directional sound, and privacy filters to increase the passenger's enjoyment of the services provided by the in-flight entertainment system.

As further discussed above, the video display unit 600 may be configured to provide multiple monitors together within a single integrated unit as illustrated in FIG. 2. In some embodiments, each of the multiple monitors may include a touchscreen monitor that generates a signal indicating a position or x-y coordinate of a user's touch on the monitor, and optionally a strength of the user's touch. The signal indicating the position may be used to generate a control signal used to control a video source of the touchscreen monitor, the video display unit 600, and/or the touchscreen monitor itself. The touchscreen monitors may use capacitive touch technology in which a touch sensitivity may be adjusted to compensate for a thickness of the polarized glass or plastic. The touchscreen monitors may also use infra-red (IR) technology in which small infra-red sensors may be disposed in front of the polarized glass or plastic to sense a position of the user's touch. The touchscreen monitors may alternatively use optical technology in which small cameras may be disposed in front of the polarized glass to sense a position of the user's touch. Alternatively, the monitors or video display unit 600 may include camera gesture recognition technology whereby movement of the user's hands or body may be sensed to generate the control signal. It will be understood that these examples are provided for exemplary purposes and that other embodiments are also included in the present inventive concept. For example, the smart screens may not only respond to “touch,” but may be responsive to any type of contact, for example, contact to the screen with a stylus or writing device.

As further illustrated in FIG. 6, the video display unit 600 may be coupled to a processor 670, and may include a memory for storing program data to be executed by the processor 670, a permanent storage such as a disk drive or solid state drive (SSD), a communications port for handling communications with external devices 655. As discussed above, the user may interact with the video display unit 600 via a user interface 665. When software modules are involved, these software modules may be stored as program instructions or computer readable code executable by the processor on a non-transitory computer-readable media such as read-only memory (ROM), random-access memory (RAM), CD-ROMs, magnetic tapes, hard disk drives (HDD's), SSD's, and optical data storage devices. The computer readable recording media may also be distributed over network coupled computer systems so that the computer readable code is stored and executed in a distributed fashion. This media can be read by the computer, stored in the memory, and executed by the processor 670.

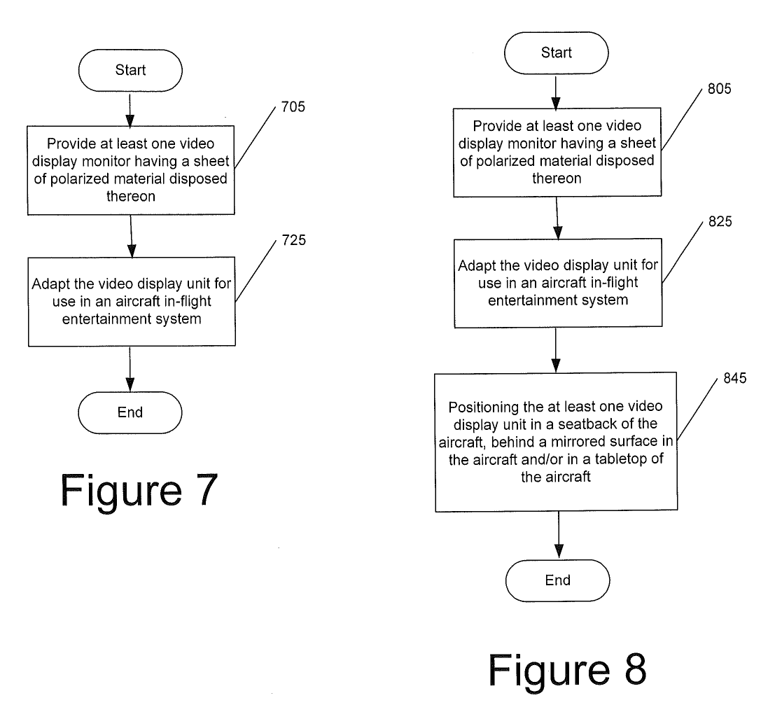

Referring now to the flowcharts of FIGS. 7 and 8, operations for providing video display units for an aircraft will be discussed. Referring first to FIG. 7, operations begin at block 705 by providing at least one video display monitor having a sheet of polarized material over substantially all of a viewing surface of the at least one video display monitor. The video display unit is adapted for use in an aircraft in-flight entertainment system by modifying the video display unit to comply with standards associated with the federal aviation administration and/or aircraft manufacturers (block 725). For example, the video display unit may be adapted to comply with at least one of electro-magnetic interface standards, flammability standards, head-impact compatibility standards and environmental standards including shock and vibration. In some embodiments, the video display unit may be further adapted for use in an aircraft in-flight entertainment system by modifying the video display unit to comply with standards associated with an aircraft manufacturer.

Referring now to FIG. 8, operations begin at block 805 by providing at least one video display monitor having a sheet of polarized material over substantially all of a viewing surface of the at least one video display monitor. The video display unit is adapted for use in an aircraft in-flight entertainment system by modifying the video display unit to comply with standards associated with the federal aviation administration and/or aircraft manufacturers (block 825). The at least one video display unit may be positioned in at least one of a seatback of the aircraft, behind a mirrored surface in the aircraft and in a tabletop of the aircraft (block 845). The sheet of polarized material may include active polarized glass, passive polarized glass, active polarized plastic and/or passive polarized plastic.

Various embodiments were described herein with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Furthermore, “coupled”, “connected”, “responsive”, or variants thereof as used herein may include wirelessly coupled, connected, or responsive. Like numbers refer to like elements throughout. The terminology used herein is for the purpose of describing particular embodiments only and is not intended to be limiting of the invention. As used herein, the singular forms “a”, “an” and “the” are intended to include the plural forms as well, unless the context clearly indicates otherwise. Well-known functions or constructions may not be described in detail for brevity and/or clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. Moreover, as used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, if used herein, the common abbreviation “e.g.”, which derives from the Latin phrase exempli gratia, may be used to introduce or specify a general example or examples of a previously mentioned item, and is not intended to be limiting of such item. If used herein, the common abbreviation “i.e.”, which derives from the Latin phrase id est, may be used to specify a particular item from a more general recitation.

Exemplary embodiments were described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit such as a digital processor, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments were disclosed herein, in connection with the following description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A video display unit comprising:
at least one video display monitor; and
at least one sheet of polarized material configured to extend on a viewing surface of the at least one video display monitor, the video display unit being adapted for use in an aircraft in-flight entertainment system.

2. The video display unit of claim 1:
wherein the at least one video display monitor comprises a plurality of video display monitors, each of the plurality of video display monitors having an associated viewing surface; and
wherein the at least one sheet of polarized material is configured to extend over substantially all the viewing surfaces of the plurality of video display monitors.

3. The video display unit of claim 2, wherein each of the plurality of video display monitors displays video content distinct from remaining ones of the plurality of video display monitors.

4. The video display unit of claim 2, wherein each of the plurality of video display monitors are configured to be powered on and/or off independently of remaining ones of the plurality of video display monitors.

5. The video display unit of claim 2:
wherein the at least one sheet of polarized material comprises a plurality of sheets of polarized material corresponding to each of the plurality of video display monitors; and
wherein each of the plurality of sheets of polarized material is configured to extend over substantially all the viewing surface of the corresponding video display monitor.

6. The video display unit of claim 1, wherein the at least one sheet of polarized material comprises active polarized glass, passive polarized glass, active polarized plastic and/or passive polarized plastic.

7. The video display unit of claim 1, wherein the video display unit is adapted for use in an aircraft in-flight entertainment system by being adapted to comply with at least one of electro-magnetic interface standards, flammability standards, head-impact compatibility standards and environmental standards including shock and vibration.

8. The video display unit of claim 1, wherein the at least one sheet of polarized material comprises a mirrored surface and wherein the video display monitor is disposed behind the mirrored surface.

9. The video display unit of claim 8:
wherein the video display monitor is configured to be unnoticed behind the mirrored surface when the video display monitor is powered off; and
wherein the video display monitor is configured to be viewed through the mirrored surface when the video display monitor is powered on.

10. The video display unit of claim 1, wherein the video display monitor is disposed in a seatback of the aircraft and/or a tabletop in the aircraft.

11. The video display unit of claim 1, wherein the video display monitor comprises an interactive screen configured to generate a signal in response to contact by a user.

12. The video display unit of claim 1, further comprising a camera configured to provide camera gesture recognition control such that the video display unit can be controlled responsive to gestures of a user.

13. The video display unit of claim 1, wherein the at least one polarized surface includes at least one of a lighting effect and a logo effect.

14. The video display unit of claim 1, further comprising a processor coupled to the at least one video display monitor, wherein the processor is configured to receive input from a user through a user interface associated with the at least one video display monitor and alter content of the at least one video display monitor based on the received input from the user.

15. The video display unit of claim 14, further comprising an in-flight entertainment system coupled to the processor.

16. A video display unit comprising:
a plurality of video display monitors; and
a sheet of polarized material configured to extend on substantially all viewing surfaces of the plurality of video display monitors, the video display unit being adapted for use in an aircraft in-flight entertainment system such that the video display unit complies with standards of the federal aviation administration and/or aircraft manufacturers.

17. The video display unit of claim 16, wherein each of the plurality of video display monitors displays video content distinct from remaining ones of the plurality of video display monitors.

18. The video display unit of claim 16, wherein each of the plurality of video display monitors are configured to be powered on and/or off independently of remaining ones of the plurality of video display monitors.

19. The video display unit of claim 16, wherein the sheet of polarized material comprises active polarized glass, passive polarized glass, active polarized plastic and/or passive polarized plastic.

20. The video display unit of claim 16, wherein the standards include at least one of electro-magnetic interface standards, flammability standards, head-impact compatibility standards and environmental standards including shock and vibration.

21. The video display unit of claim 16, wherein the sheet of material comprises a mirrored surface and wherein the video display monitor is disposed behind the mirrored surface.

22. The video display unit of claim 16, wherein the video display monitor is disposed in a seatback of the aircraft and/or a tabletop in the aircraft.

23. A method of providing a video display unit for an aircraft, the method comprising:
providing at least one video display monitor having a sheet of polarized material over substantially all of a viewing surface of the at least one video display monitor; and
adapting the video display unit for use in an aircraft in-flight entertainment system by modifying the video display unit to comply with standards associated with the federal aviation administration.

24. The method of claim 23, wherein adapting the video display unit for use in an aircraft in-flight entertainment system further comprises modifying the video display unit to comply with standards associated with an aircraft manufacturer.

25. The method of claim 23, wherein adapting the video display unit for use in an aircraft in-flight entertainment system by modifying the video display unit to comply with standards associated with the federal aviation administration comprises modifying the video display unit to comply with at least one of electro-magnetic interface standards, flammability standards, head-impact compatibility standards and environmental standards including shock and vibration.

26. The method of claim 23:
wherein providing the at least one video display monitor comprises providing a plurality of video display monitors, each of the plurality of video display monitors having an associated viewing surface; and
wherein the sheet of polarized material is configured to extend over substantially all the viewing surfaces of the plurality of video display monitors.

27. The method of claim 23, further comprising positioning the at least one video display unit in a seatback of the aircraft, behind a mirrored surface in the aircraft and/or in a tabletop of the aircraft.

28. The method of claim 23, wherein the sheet of polarized material comprises active polarized glass, passive polarized glass, active polarized plastic and/or passive polarized plastic.
